(19) United States
(12) Patent Application Publication
(10) Pub. No.: US 2025/0067383 A1
(43) Pub. Date: Feb. 27, 2025

(54) VEHICLE-COOLANT HEAT INSULATING TUBE AND MANUFACTURING METHOD THEREFOR

(71) Applicant: TOYODA GOSEI CO., LTD., Kiyosu-shi (JP)

(72) Inventors: Hideo NAGAI, Kiyosu-shi (JP); Kenichiro KANEKO, Kiyosu-shi (JP)

(21) Appl. No.: 18/781,307

(22) Filed: Jul. 23, 2024

(30) Foreign Application Priority Data
Aug. 21, 2023 (JP) 2023-134274

(51) Int. Cl. F16L 59/14; B29C 48/09; B29K 105/04; B29L 23/00; B60H 1/00

(52) U.S. Cl. CPC F16L 59/14; B29C 48/09; B60H 1/00571; B29K 2105/04; B29K 2995/0082; B29L 2023/225

(57) ABSTRACT

Provided is a vehicle-coolant heat insulating tube imparted with a heat insulation property and capable of maintaining the shape in manufacturing and usage. A vehicle-coolant heat insulating tube 1 having a flow path 4 for a vehicle coolant includes: a flow path formation layer 2 defining and forming the flow path 4 therein; and a heat insulating layer 3 covering the flow path formation layer 2 from a radially outer side. A porosity of the flow path formation layer 2 is smaller than 208, and a porosity of the heat insulating layer 3 is 20% or greater and smaller than 80%.

### TECHNICAL FIELD

The present disclosure relates to a vehicle-coolant heat insulating tube provided to a vehicle and having a flow path for a vehicle coolant, a manufacturing method for the vehicle-coolant heat insulating tube, and a vehicle-coolant heat insulating tube obtained by the manufacturing method.

### BACKGROUND ART

Among vehicular provided devices provided to a vehicle, for example, an electric motor, a vehicle driving battery, and the like are hindered from giving sufficient performance when having an excessively high temperature or an excessively low temperature. A general vehicle is provided with a heat exchanger for keeping such a vehicular provided device at an appropriate temperature. A vehicle coolant flows through the heat exchanger, and the heat exchanger performs heat exchange with the vehicular provided device via the vehicle coolant.

The heat exchanger is connected to a vehicle-coolant tank, a liquid-feeding pump, or the like via a vehicle-coolant heat insulating tube. The vehicle-coolant heat insulating tube is considered to have a flow path for a vehicle coolant leading to the heat exchanger, the tank, the liquid-feeding pump, or the like.

In order to keep the vehicular provided device at an appropriate temperature, keeping a vehicle coolant which undergoes heat exchange with the vehicular provided device, in a predetermined temperature range, is considered effective. In order to keep the vehicle coolant in the predetermined temperature range, using a vehicle-coolant heat insulating tube imparted with a heat insulation property for a vehicle-coolant tube through which the vehicle coolant flows is considered effective.

One of methods for imparting a heat insulation property to the vehicle-coolant tube to obtain the vehicle-coolant heat insulating tube is to select a heat insulating material as a material of the vehicle-coolant heat insulating tube.

Japanese Laid-Open Patent Publication No. 2022-143892 (hereinafter, Patent Literature 1) shows a pipe through which a high-temperature liquid chemical flows in a semiconductor manufacturing apparatus. Patent Literature 1 describes that the pipe is formed by a porous tube, whereby the temperature of the liquid chemical is kept.

Patent Literature 1 shows, as a specific example of the porous tube, a porous tube having a porous portion made of polytetrafluoroethylene (PTFE) and an acid-base indicator carried at the porous portion.

For reference, when an acidic or basic liquid chemical flowing through the porous tube leaks out, the liquid chemical reacts with the acid-base indicator to exhibit a color. Thus, with the porous tube, there is an advantage that a heat insulation property is provided and a part of the porous tube where a liquid chemical is leaked out is easily detected.

Forming the vehicle-coolant tube by the porous portion described above is expected to obtain the vehicle-coolant heat insulating tube imparted with a heat insulation property.

### SUMMARY OF INVENTION

### Technical Problem

As described above, forming the vehicle-coolant tube by the porous portion shown in Patent Literature 1 is expected to obtain the vehicle-coolant heat insulating tube imparted with a heat insulation property.

Here, because of being connected to a target member such as the heat exchanger described above, the vehicle-coolant tube is required to be connected with high strength to the target member, as well as having the heat insulation property described above.

However, the porous portion made of PTFE described above is not so high in rigidity and strength and therefore may have difficulty in maintaining the shape thereof. Thus, the vehicle-coolant heat insulating tube formed by the porous portion is likely to be poor in connection strength to the target member.

Further, the vehicle-coolant heat insulating tube may need to be formed in a bent shape in accordance with arrangement of a vehicular provided device that is a heat exchange target, the heat exchanger, another vehicular provided device, or the like. However, since the vehicle-coolant heat insulating tube formed by the porous portion is poor in rigidity and strength, the shape of the vehicle-coolant heat insulating tube may be unable to be maintained in bending work.

In addition, a cool or hot coolant flows inside the vehicle-coolant heat insulating tube, and therefore the vehicle-coolant heat insulating tube itself is also subjected to heat. Due to the heat, the vehicle-coolant heat insulating tube may be deformed or in some cases, softened. As a result, it is also assumed that connection between the vehicle-coolant heat insulating tube and the target member is released or the bent shape becomes difficult to be maintained.

Accordingly, there are circumstances in which a vehicle-coolant heat insulating tube imparted with a heat insulation property and capable of maintaining the shape in manufacturing and usage is desired.

The present disclosure has been made in view of the above circumstances, and an object of the present disclosure is to provide a vehicle-coolant heat insulating tube imparted with a heat insulation property and capable of maintaining the shape in manufacturing and usage.

### Solution to Problem

One aspect of a vehicle-coolant heat insulating tube of the present disclosure to achieve the above object is as follows.

(1) A vehicle-coolant heat insulating tube having a flow path for a vehicle coolant, the vehicle-coolant heat insulating tube comprising:
a flow path formation layer defining and forming the flow path therein; and
a heat insulating layer covering the flow path formation layer from a radially outer side, wherein
a porosity of the flow path formation layer is smaller than 20%, and a porosity of the heat insulating layer is 20% or greater and smaller than 80%.

Another aspect of the vehicle-coolant heat insulating tube of the present disclosure to achieve the above object is as follows.

(2) A vehicle-coolant heat insulating tube having a flow path for a vehicle coolant, the vehicle-coolant heat insulating tube comprising:
a flow path formation layer defining and forming the flow path therein; and
a heat insulating layer covering the flow path formation layer from a radially outer side, wherein
a Young's modulus of the flow path formation layer is 1000 MPa or greater and 4000 MPa or smaller, and a Young's modulus of the heat insulating layer is smaller than 1000 MPa.

One aspect of a manufacturing method for a vehicle-coolant heat insulating tube of the present disclosure to achieve the above object is as follows.

(3) A manufacturing method for a vehicle-coolant heat insulating tube which has a flow path for a vehicle coolant and includes a flow path formation layer defining and forming the flow path therein and a heat insulating layer covering the flow path formation layer from a radially outer side, the manufacturing method comprising:
an extrusion molding step of performing extrusion molding using a flow path formation material which is a material of the flow path formation layer and a heat insulating material which is a material of the heat insulating layer, to form the flow path formation layer having a porosity of smaller than 20% and the heat insulating layer having a porosity of 20% or greater and smaller than 80%.

Another aspect of a manufacturing method for the vehicle-coolant heat insulating tube of the present disclosure to achieve the above object is as follows.

(4) A manufacturing method for a vehicle-coolant heat insulating tube which has a flow path for a vehicle coolant and includes a flow path formation layer defining and forming the flow path therein and a heat insulating layer covering the flow path formation layer from a radially outer side, the manufacturing method comprising:
an extrusion molding step of performing extrusion molding using a flow path formation material which is a material of the flow path formation layer and a heat insulating material which is a material of the heat insulating layer, to form the flow path formation layer having a Young's modulus of 1000 MPa or greater and 4000 MPa or smaller, and the heat insulating layer having a Young's modulus of smaller than 1000 MPa.

Another aspect of the vehicle-coolant heat insulating tube of the present disclosure to achieve the above object is as follows.

(5) A vehicle-coolant heat insulating tube extrusion-molded by the manufacturing method in the above (3).

Another aspect of the vehicle-coolant heat insulating tube of the present disclosure to achieve the above object is as follows.

(6) A vehicle-coolant heat insulating tube extrusion-molded by the manufacturing method in the above (4).

The vehicle-coolant heat insulating tube of the present disclosure is a vehicle-coolant heat insulating tube imparted with a heat insulation property and capable of maintaining the shape in manufacturing and usage. In addition, the manufacturing method for the vehicle-coolant heat insulating tube of the present disclosure provides a vehicle-coolant heat insulating tube imparted with a heat insulation property and capable of maintaining the shape in manufacturing and usage.

### BRIEF DESCRIPTION OF DRAWINGS

FIG. 1 schematically illustrates the outer appearance of a vehicle-coolant heat insulating tube of embodiment 1;

FIG. 2 schematically illustrates a radial-direction cross-section of the vehicle-coolant heat insulating tube of embodiment 1;

FIG. 3 schematically illustrates an axial-direction cross-section of the vehicle-coolant heat insulating tube of embodiment 1;

FIG. 4 schematically illustrates a radial-direction cross-section of a vehicle-coolant heat insulating tube of embodiment 2; and

FIG. 5 schematically illustrates an axial-direction cross-section of the vehicle-coolant heat insulating tube of embodiment 2.

### DESCRIPTION OF EMBODIMENTS

Hereinafter, a vehicle-coolant heat insulating tube and a manufacturing method therefor of the present disclosure will be described using specific examples.

Hereinafter, unless otherwise specified, the vehicle-coolant heat insulating tube of the present disclosure according to the aspect in the above (1) may be referred to as a vehicle-coolant heat insulating tube of a first aspect. In addition, unless otherwise specified, the vehicle-coolant heat insulating tube of the present disclosure according to the aspect in the above (2) may be referred to as a vehicle-coolant heat insulating tube of a second aspect. Further, the vehicle-coolant heat insulating tube of the first aspect and the vehicle-coolant heat insulating tube of the second aspect may be collectively referred to as the vehicle-coolant heat insulating tube of the present disclosure.

In addition, unless otherwise specified, the manufacturing method for the vehicle-coolant heat insulating tube of the present disclosure according to the aspect in the above (3) may be referred to as a manufacturing method of a third aspect. Unless otherwise specified, the manufacturing method for the vehicle-coolant heat insulating tube of the present disclosure according to the aspect in the above (4) may be referred to as a manufacturing method of a fourth aspect. Further, the manufacturing method of the third aspect and the manufacturing method of the fourth aspect may be collectively referred to as the manufacturing method of the present disclosure.

Unless otherwise specified, a numerical range “x to y” described in the specification includes a lower limit x and an upper limit y. Such an upper limit value and a lower limit value, and values described in embodiments, may be arbitrarily combined to form a numerical range. Further, any values selected from such a numerical range may be used as an upper limit value and a lower limit value.

The vehicle-coolant heat insulating tube of the present disclosure is a tube having a flow path for a vehicle coolant. The vehicle-coolant heat insulating tube of the present disclosure is considered to have the flow path therein.

The coolant flowing through the flow path may be any fluid that flows through the flow path of the vehicle-coolant heat insulating tube and undergoes heat exchange with a vehicular provided device as a target, and may be a liquid or a gas.

A specific example of the coolant is a coolant obtained by adding, to water, an additive such as a preservative, a lubricant, or a corrosion inhibitor, called a long life coolant (LLC). However, the coolant is not limited thereto.

The coolant may be referred to as a heat exchange medium, a heat medium, a heat carrier, or the like.

The vehicle-coolant heat insulating tube of the present disclosure includes a flow path formation layer and a heat insulating layer. Of these, the flow path formation layer is a part defining and forming the flow path therein and is considered to be a layer adjacent to the flow path. The heat insulating layer is a part covering the flow path formation layer from a radially outer side.

In the vehicle-coolant heat insulating tube of the present disclosure, the flow path formation layer is a part defining and forming the flow path and serving as a connection portion to be connected to a target member such as a heat exchanger. The heat insulating layer is a part for providing a heat insulation property.

In the vehicle-coolant heat insulating tube of the first aspect, a porosity of the flow path formation layer is smaller than 20%, and a porosity of the heat insulating layer is 20% or greater and smaller than 80%.

In the vehicle-coolant heat insulating tube of the first aspect, since the porosity of the flow path formation layer is smaller than 20%, the strength and the rigidity of the flow path formation layer are increased and thus the shape is easily maintained in manufacturing and usage. As a result, the shape of the vehicle-coolant heat insulating tube of the first aspect is appropriately maintained also in bending work and usage, and the connection strength to the target member is also increased.

In the vehicle-coolant heat insulating tube of the second aspect, a Young's modulus of the flow path formation layer is 1000 MPa or greater and 4000 MPa or smaller, and a Young's modulus of the heat insulating layer is smaller than 1000 MPa.

In the vehicle-coolant heat insulating tube of the second aspect, a layer having a greater Young's modulus than the heat insulating layer, in other words, a layer having greater rigidity and being less deformable, is selected as the flow path formation layer.

Specifically, in the vehicle-coolant heat insulating tube of the second aspect, the Young's modulus of the flow path formation layer is specified as 1000 MPa or greater and 4000 MPa or smaller. Such a flow path formation layer is sufficiently less deformable to an extent that maintains the shape thereof, and is elastically deformable to an extent that allows connection to the target member. Thus, the shape of the vehicle-coolant heat insulating tube of the second aspect is appropriately maintained also in bending work and usage, and the connection strength to the target member is also increased.

The manufacturing method of the present disclosure is a manufacturing method for a tube having the flow path formation layer and the heat insulating layer described above. In the manufacturing method of the present disclosure, the vehicle-coolant heat insulating tube is extrusion-molded. More specifically, the manufacturing method of the present disclosure includes an extrusion molding step of performing extrusion molding using a flow path formation material which is a material of the flow path formation layer and a heat insulating material which is a material of the heat insulating layer, to form the flow path formation layer and the heat insulating layer.

The vehicle-coolant heat insulating tube of the present disclosure described above has the flow path for the vehicle coolant and includes: the flow path formation layer defining and forming the flow path therein; and the heat insulating layer covering the flow path formation layer from the radially outer side. Such a vehicle-coolant heat insulating tube may be manufactured by winding and adhering a heat insulating layer around the radially outer side of a flow path formation layer prepared in advance, for example.

However, such a vehicle-coolant heat insulating tube of a wound-adhered type obtained by winding and adhering the heat insulating layer around the radially outer side of the flow path formation layer prepared in advance has a large outer shape and thus is bulky. Such a vehicle-coolant heat insulating tube to be provided to a vehicle is often required to be compact, and therefore the vehicle-coolant heat insulating tube of the wound-adhered type described above may be inadequate for the requirement.

In addition, in the vehicle-coolant heat insulating tube of the wound-adhered type described above, depending on a combination of the shape and the material thereof, or the like, the flow path formation layer and the heat insulating layer are not adhered with sufficient strength, so that the shape of the vehicle-coolant heat insulating tube may be difficult to be maintained.

In this case, for example, the flow path formation layer and the heat insulating layer are assumed to be separated from each other partially or entirely.

In the manufacturing method of the present disclosure, the vehicle-coolant heat insulating tube is manufactured using an extrusion molding method. More specifically, as described above, the manufacturing method of the present disclosure includes the extrusion molding step of performing extrusion molding using the flow path formation material which is the material of the flow path formation layer and the heat insulating material which is the material of the heat insulating layer, to form the flow path formation layer and the heat insulating layer.

In the vehicle-coolant heat insulating tube manufactured by the extrusion molding method, i.e., the vehicle-coolant heat insulating tube obtained by the manufacturing method of the present disclosure, the flow path formation layer and the heat insulating layer are fused to be strongly joined to each other, whereby separation between the flow path formation layer and the heat insulating layer is sufficiently suppressed.

With the manufacturing method of the present disclosure including the above extrusion molding step, the vehicle-coolant heat insulating tube having the flow path formation layer and the heat insulating layer fused to each other, or a precursor thereof, is obtained with one step, i.e., the extrusion molding step. That is, with the manufacturing method of the present disclosure, the vehicle-coolant heat insulating tube having the flow path formation layer and the heat insulating layer strongly joined to each other is easily manufactured.

Further, the extrusion molding forms the heat insulating layer in a compact size without waste, as compared to the method for manufacturing the vehicle-coolant heat insulating tube of the wound-adhered type described above, i.e., the method of winding and adhering the heat insulating layer around the radially outer side of the flow path formation layer prepared in advance. Thus, the vehicle-coolant heat insulating tube obtained by the manufacturing method of the present disclosure has an advantage of being compact as compared to the vehicle-coolant heat insulating tube of the wound-adhered type described above.

In the manufacturing method of the third aspect of the present disclosure, in the extrusion molding step, the flow path formation layer having a porosity of smaller than 20% and the heat insulating layer having a porosity of 20% or greater and smaller than 80%, are formed.

With the manufacturing method of the third aspect as described above, the vehicle-coolant heat insulating tube of the first aspect described above is easily manufactured.

In addition, the vehicle-coolant heat insulating tube obtained by the manufacturing method of the third aspect, i.e., the vehicle-coolant heat insulating tube of the fifth aspect described above, is compact, and the shape thereof is appropriately maintained also in bending work and usage and the connection strength to the target member is also increased, as in the vehicle-coolant heat insulating tube of the first aspect described above.

In the manufacturing method of the fourth aspect of the present disclosure, in the extrusion molding step, the flow path formation layer having a Young's modulus of 1000 MPa or greater and 4000 MPa or smaller, and the heat insulating layer having a Young's modulus of smaller than 1000 MPa, are formed.

With the manufacturing method of the fourth aspect as described above, the vehicle-coolant heat insulating tube of the second aspect described above is easily manufactured.

In addition, the vehicle-coolant heat insulating tube obtained by the manufacturing method of the fourth aspect, i.e., the vehicle-coolant heat insulating tube of the sixth aspect described above, is compact, and the shape thereof is appropriately maintained also in bending work and usage and the connection strength to the target member is also increased, as in the vehicle-coolant heat insulating tube of the second aspect described above.

Hereinafter, the vehicle-coolant heat insulating tube and the manufacturing method therefor of the present disclosure will be described on a constituent element basis.

The vehicle-coolant heat insulating tube of the present disclosure includes the flow path formation layer and the heat insulating layer.

The flow path formation layer has a shape having a flow path therein, i.e., a tubular shape. In addition, the flow path formation layer is, of the vehicle-coolant heat insulating tube of the present disclosure, a part defining and forming the flow path and being elastically deformable to an extent that allows connection to the target member. Of the target member, a part to be connected to the flow path formation layer has a flow path through which the coolant flows. When the flow path formation layer and the target member are connected, the flow path of the target member communicates with the flow path of the flow path formation layer.

As a connection method for the flow path formation layer and the target member, specifically, a method of inserting an end of the target member into the flow path of the flow path formation layer so that the flow path of the flow path formation layer and the flow path of the target member communicate with each other, or a method of inserting an end of the flow path formation layer into the flow path of the target member so that the flow path of the flow path formation layer and the flow path of the target member communicate with each other, is preferably used.

The flow path formation layer may be elastically deformable or not elastically deformable. However, in order to maintain connection between the flow path formation layer and the target member in an appropriate state, the flow path formation layer that is deformable to a certain extent is considered desirable.

Therefore, as the material of the flow path formation layer, a material that is not elastically deformable, e.g., metal or ceramic, may be selected, but preferably, an elastically deformable material such as resin, rubber, or elastomer is selected.

Here, the vehicle-coolant heat insulating tube of the present disclosure preferably has a light weight, because of being provided to a vehicle. Also from this point of view, using resin, rubber, or elastomer alone or some of these in combination as the material of the flow path formation layer is considered preferable.

As another preferable example, the material of the flow path formation layer may be obtained as follows: a base material is formed by one or more kinds of various resins, rubbers, and elastomers, and then a filler such as metal or glass is added to the base material. In this case, a function derived from the filler is imparted to the flow path formation layer.

Specific examples of a preferable material of the flow path formation layer include polypropylene (PP), polyphenylene sulfide (PPS), and polyamide (PA). As described above, each of these materials may be used alone or some of these may be used in combination. At least one of these materials may be used in combination with another material.

The flow path formation layer preferably has rigidity that is high to a certain extent, and as described above, in the vehicle-coolant heat insulating tube of the second aspect, the Young's modulus of the flow path formation layer is 1000 MPa or greater and 4000 MPa or smaller.

The flow path formation layer whose Young's modulus is in the above range is sufficiently less deformable to an extent that maintains the shape thereof, and is elastically deformable to an extent that allows connection to the target member. Therefore, also in the vehicle-coolant heat insulating tube of the first aspect, the Young's modulus of the flow path formation layer is preferably 1000 MPa or greater and 4000 MPa or smaller.

In addition, in order to impart the flow path formation layer with an ability for withstanding usage as the flow path for the vehicle coolant and providing rigidity to a certain extent, the porosity of the flow path formation layer is preferably reduced.

In the vehicle-coolant heat insulating tube of the first aspect, the porosity of the flow path formation layer is specified as smaller than 20%.

Also in the vehicle-coolant heat insulating tube of the second aspect, for the same reason as described above, the porosity of the flow path formation layer is preferably reduced, and specifically, the porosity of the flow path formation layer is preferably smaller than 25%, smaller than 20%, or smaller than 15%. Regarding the porosity, a lower limit value is not particularly set, and the porosity of the flow path formation layer may be 0%.

In the specification, the porosity may be represented as, for example, a percentage using a true density and an apparent density, i.e., on the basis of the following formula [1]. The apparent density may be measured in conformity with weighting in liquid prescribed in JIS K 0061. The true density may be measured in conformity with a pycnometer method using a Gay-Lussac pycnometer, a pycnometer method using a graduated pycnometer, or a pycnometer method using an Ostwald pycnometer, prescribed in JIS K 0061.

$$Porosity ( \% ) = 100 - \{ 100 \times ( apparent density / true density ) \} \qquad [ 1 ]$$

In a case where the porosity of the flow path formation layer is greater than 0%, i.e., the flow path formation layer is a porous body having pores, the flow path formation layer may be an open-cell porous body in which a plurality of pores communicate with each other, or may be a closed-cell porous body in which pores are independent of each other. In some cases, gas, liquid, or solid different from the main material defining and forming the pores may be contained in the pores.

In a case where the flow path formation layer is a porous body, the average pore size of the flow path formation layer is preferably 10 μm to 600 μm. As a measurement method for the average pore size, the following method may be selected, for example.

First, a cross-section of the flow path formation layer at an arbitrary position is taken. Then, in the cross-section, an arbitrary area of 5 mm×5 mm is set. For all the pores present in this area, the maximum diameters thereof are measured by the naked eyes or under a microscope. Here, the maximum diameter of the pore refers to the maximum value of the distance between two parallel tangents to the pore. The average value of the maximum diameters of the pores present in the above area is calculated and used as the average pore size.

In view of maintaining the shape of the vehicle-coolant heat insulating tube in usage, a material whose linear expansion coefficient is small to a certain extent is preferably selected as the material of the flow path formation layer. When the linear expansion coefficient of the flow path formation layer is small, the deformation amount thereof due to temperature change is small.

Specifically, the linear expansion coefficient of the material of the flow path formation layer is preferably 5 to 11×10⁻⁵ (/° C.).

The heat insulating layer is a layer covering the flow path formation layer from the radially outer side, and is a part for providing a heat insulation property, of the vehicle-coolant heat insulating tube of the present disclosure.

Forming the heat insulating layer as a porous body having pores imparts a high heat insulation property to the heat insulating layer. In the vehicle-coolant heat insulating tube of the first aspect, the porosity of the heat insulating layer is specified as 20% or greater and smaller than 80%.

Also in the vehicle-coolant heat insulating tube of the second aspect, for the same reason as described above, the heat insulating layer is preferably a porous body, and the porosity thereof is preferably 158 or greater and smaller than 90%, 20% or greater and smaller than 80%, or 25% or greater and smaller than 70%.

In the vehicle-coolant heat insulating tube of the first aspect, the Young's modulus of the heat insulating layer is specified as smaller than 1000 MPa.

Here, the heat insulating layer is not a part required to serve as a connection portion to the target member, unlike the flow path formation layer. Therefore, the Young's modulus of the heat insulating layer may be much smaller than the Young's modulus of the flow path formation layer. From this point of view, the Young's modulus of the heat insulating layer may be 0.5 MPa or greater and 50 MPa or smaller, 0.5 MPa or greater and 10 MPa or smaller, or 0.5 MPa or greater and 5 MPa or smaller, for example.

The heat insulating layer may cover the entire flow path formation layer throughout, or may cover only a part of the flow path formation layer. For example, in the vehicle-coolant heat insulating tube of the present disclosure, one or both ends in the axial direction of the flow path formation layer may be exposed without being covered by the heat insulating layer.

As described above, the heat insulating layer may cover the entire flow path formation layer or may cover only a part thereof, but the heat insulating layer more preferably covers a more part of the surface of the flow path formation layer.

Specifically, where the surface area of the flow path formation layer is defined as 100%, the heat insulating layer preferably covers 60% or more of the surface area, more preferably covers 70% or more of the surface area, and particularly preferably covers 80% or more of the surface area. Here, the surface area of the flow path formation layer refers to an apparent surface area calculated under the assumption that the flow path formation layer has no pores.

The material of the heat insulating layer is desired to be a material having a heat insulation property. In other words, a material having a small thermal conductivity is preferably selected as the material of the heat insulating layer. Specifically, the thermal conductivity of the material of the heat insulating layer is preferably 5 W/(m·° C.) or smaller, 3 (m·° C.) or smaller, or 1 (m·° C.) or smaller.

As the material of the heat insulating layer, resin, rubber, elastomer, or the like is particularly preferably selected.

Specific examples of the material of the heat insulating layer include thermoplastic olefinic elastomer (TPO), thermoplastic styrenic elastomer (TPS), PP, PPS, and PA. The heat insulating layer is preferably a foamed body made of the above material. Each of the above materials may be used alone or some of these may be used in combination. At least one of these materials may be used in combination with another material.

In a case where the heat insulating layer is a porous body, the heat insulating layer may be an open-cell porous body or may be a closed-cell porous body. Also in the pores of the heat insulating layer, in some cases, gas, liquid, or solid different from the main material defining and forming the pores may be contained.

In a case where the heat insulating layer is a porous body, the average pore size of the heat insulating layer is preferably 10 μm to 600 μm, as with the average pore size of the flow path formation layer.

In a case where the heat insulating layer is a porous body, in particular, in a case where the heat insulating layer is a foamed body such as foamed resin, foamed rubber, or foamed elastomer, a small-porosity layer called a skin layer may be formed on the surface of the heat insulating layer. The skin layer is a layer formed when the heat insulating layer is formed, and of a molding material injected into a mold, a part in contact with a die surface of the mold is rapidly cooled, whereby the skin layer is formed.

The skin layer is made of the same material as the heat insulating layer and is formed integrally with the heat insulating layer. The skin layer is a layered part having a smaller porosity than the other part of the heat insulating layer as described above, and is distinguishable from the flow path formation layer by the fact that the thickness of the skin layer is very small.

Specifically, the thickness of the skin layer is considered to be 1 mm or smaller.

In contrast, the thickness of the heat insulating layer is greater than the thickness of the flow path formation layer, and is preferably equal to or greater than 1.5 times the thickness of the flow path formation layer. The thickness of a protection layer described later is smaller than the thickness of the flow path formation layer, and is preferably equal to or smaller than 0.8 times, 0.7 times, or 0.5 times the thickness of the flow path formation layer.

The vehicle-coolant heat insulating tube of the present disclosure may have a double-layer structure having the flow path formation layer and the heat insulating layer, or may have a multilayer structure having three or more layers including the protection layer in addition to the flow path formation layer and the heat insulating layer.

The protection layer is a layer covering the heat insulating layer from the radially outer side, and may be formed of a single layer or multiple layers including two or more layers.

In the vehicle-coolant heat insulating tube of the present disclosure, the heat insulating layer is a layer having a greater porosity or a smaller Young's modulus than the flow path formation layer, and is considered to be a fragile layer as compared to the flow path formation layer.

In the present disclosure, the protection layer is further provided on the outer side of the heat insulating layer described above, whereby the heat insulating layer is protected and thus the entire vehicle-coolant heat insulating tube is protected.

Preferably, the protection layer is at least one of a layer having greater strength than the heat insulating layer, a layer having higher weather resistance than the heat insulating layer, or a layer having higher heat resistance than the heat insulating layer, for example.

The protection layer may be any layer that reinforces the heat insulating layer, and the material, the structure, and the like thereof are not particularly limited. However, the porosity of the protection layer is preferably smaller than the porosity of the heat insulating layer. Specifically, the porosity of the protection layer is preferably smaller than 20%.

The protection layer may cover the entire surface of the heat insulating layer from the outer side, or may cover only a part of the surface of the heat insulating layer from the outer side. In order to protect the heat insulating layer highly reliably by the protection layer, the protection layer more preferably covers a more part of the surface of the heat insulating layer.

Specifically, where the surface area of the heat insulating layer is defined as 100%, the protection layer preferably covers 60% or more of the surface area, more preferably covers 70% or more of the surface area, and particularly preferably covers 80% or more of the surface area. Here, the surface area of the heat insulating layer refers to an apparent surface area calculated under the assumption that the heat insulating layer has no pores.

As the material of the protection layer, for example, at least one of PP, PPS, and PA may be selected, as with the flow path formation layer. At least one of these materials may be used in combination with another material. Preferably, the material of the protection layer is different from the material of the heat insulating layer.

Hereinafter, the vehicle-coolant heat insulating tube and the manufacturing method therefor of the present disclosure will be described using specific examples.

### Embodiment 1

A vehicle-coolant heat insulating tube of embodiment 1 is the vehicle-coolant heat insulating tube of the first aspect and the vehicle-coolant heat insulating tube of the second aspect. In addition, a manufacturing method of embodiment 1 is the manufacturing method of the third aspect and the manufacturing method of the fourth aspect. Therefore, the vehicle-coolant heat insulating tube of embodiment 1 is considered to be the vehicle-coolant heat insulating tube of the fifth aspect and the vehicle-coolant heat insulating tube of the sixth aspect.

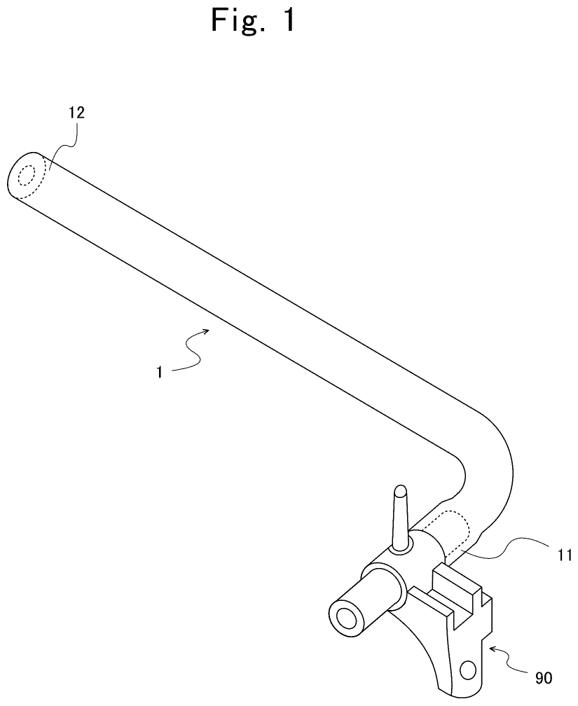

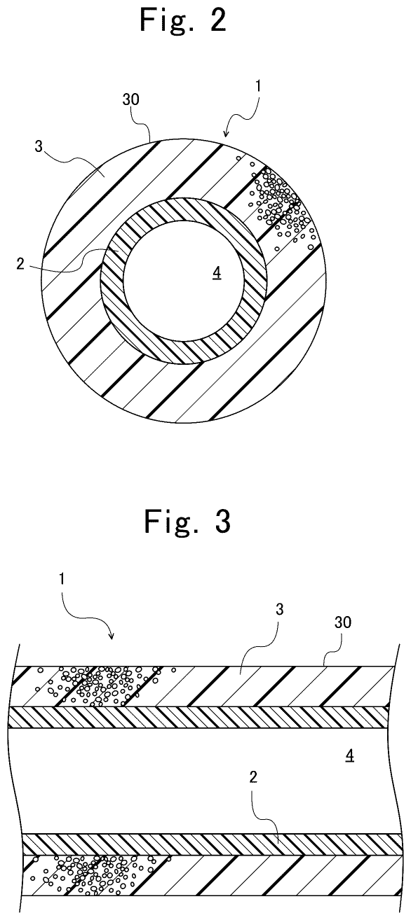

FIG. 1 schematically illustrates the outer appearance of the vehicle-coolant heat insulating tube of embodiment 1. FIG. 2 schematically illustrates a radial-direction cross-section of the vehicle-coolant heat insulating tube of embodiment 1. FIG. 3 schematically illustrates an axial-direction cross-section of the vehicle-coolant heat insulating tube of embodiment 1.

A vehicle-coolant heat insulating tube 1 of embodiment 1 is provided to a vehicle (not shown) and forms a part of the flow path for the vehicle coolant.

As shown in FIG. 1, the vehicle-coolant heat insulating tube 1 of embodiment 1 has a substantially cylindrical shape and is bent substantially in an L shape.

One end 11 in the axial direction of the vehicle-coolant heat insulating tube 1 of embodiment 1 is connected to a liquid-feeding pump (not shown) which is a target member, via a joint 90 which is an injection-molded product. Another end 12 is connected to a heat exchanger (not shown) which is a target member.

As shown in FIG. 2 and FIG. 3, the vehicle-coolant heat insulating tube 1 of embodiment 1 has a double-layer structure having a flow path formation layer 2 and a heat insulating layer 3.

The flow path formation layer 2 is made of PP and has a substantially cylindrical shape. The inside of the flow path formation layer 2 having a substantially cylindrical shape is hollow, and the inside serves as a flow path 4 for the vehicle coolant. That is, the flow path formation layer 2 is considered to define and form the flow path 4 for the vehicle coolant.

The heat insulating layer 3 is made of TPO foam and has a substantially cylindrical shape covering the entire flow path formation layer 2 from the radially outer side.

In the vehicle-coolant heat insulating tube 1 of embodiment 1, the porosity of the flow path formation layer 2 was approximately 0% and the porosity of the heat insulating layer 3 was approximately 50%. The average pore size of the heat insulating layer 3 was approximately 300 μm.

The Young's modulus of the flow path formation layer 2 was approximately 1350 MPa, and the Young's modulus of the heat insulating layer 3 was much smaller than 1000 MPa.

In the vehicle-coolant heat insulating tube 1 of embodiment 1, the linear expansion coefficient of the flow path formation layer 2 was 11×10⁻⁵ (/° C.).

The thickness of the flow path formation layer 2 was 1.5 mm, and the thickness of the heat insulating layer 3 was 3 mm. For reference, the vehicle-coolant heat insulating tube 1 of embodiment 1 has a skin layer 30 formed on the surface of the heat insulating layer 3, i.e., the surface of the vehicle-coolant heat insulating tube 1. The thickness of the skin layer 30 was a little smaller than 1 mm.

In the vehicle-coolant heat insulating tube 1 of embodiment 1, a porous body having a porosity of approximately 50% is used as the heat insulating layer 3. Thus, a sufficient heat insulation property is imparted to the vehicle-coolant heat insulating tube 1 of embodiment 1.

In the vehicle-coolant heat insulating tube 1 of embodiment 1, the flow path formation layer 2 has a porosity of smaller than 20% and a Young's modulus of approximately 1350 MPa. Thus, in the vehicle-coolant heat insulating tube 1 of embodiment 1, the strength and the rigidity of the flow path formation layer 2 are sufficiently increased. As a result, the shape of the vehicle-coolant heat insulating tube 1 of embodiment 1 is stably maintained also in bending work and usage. In addition, the connection strength of the vehicle-coolant heat insulating tube 1 of embodiment 1 to the target member is sufficiently increased.

The manufacturing method for the vehicle-coolant heat insulating tube 1 of embodiment 1 will be described below.

The manufacturing method for the vehicle-coolant heat insulating tube 1 of embodiment 1 includes the extrusion molding step based on the extrusion molding method called two-color extrusion molding or co-extrusion molding.

In the extrusion molding step, the flow path formation material which is the material of the flow path formation layer 2 and the heat insulating material which is the material of the heat insulating layer 3 were separately put into feeders of an extrusion molding machine (not shown), and then through a mold of the extrusion molding machine, a straight tubular body having the flow path formation layer 2 and the heat insulating layer 3 was extrusion-molded.

The tubular body obtained in the above extrusion molding step was bent while being heated, whereby the vehicle-coolant heat insulating tube 1 of embodiment 1 bent substantially in an L shape was obtained.

With the manufacturing method for the vehicle-coolant heat insulating tube 1 of embodiment 1, the flow path formation layer 2 and the heat insulating layer 3 are integrally molded in the extrusion molding step, thus obtaining the vehicle-coolant heat insulating tube 1 of embodiment 1 having the heat insulating layer 3 in a compact size without waste, unlike the existing vehicle-coolant heat insulating tube of the wound-adhered type described above.

In addition, with the manufacturing method for the vehicle-coolant heat insulating tube 1 of embodiment 1, the flow path formation layer 2 and the heat insulating layer 3 are molded at the same time in the extrusion molding step, whereby the flow path formation layer 2 and the heat insulating layer 3 are fused to be strongly joined to each other. Thus, separation between the flow path formation layer 2 and the heat insulating layer 3 is suppressed with high reliability, so that the vehicle-coolant heat insulating tube 1 of embodiment 1 having high strength and high durability is obtained.

Further, a process for molding and fusing the flow path formation layer 2 and the heat insulating layer 3 only needs to include one step, i.e., the extrusion molding step. Thus, with the manufacturing method for the vehicle-coolant heat insulating tube 1 of embodiment 1, the vehicle-coolant heat insulating tube 1 of embodiment 1 is easily manufactured.

### Embodiment 2

A vehicle-coolant heat insulating tube of embodiment 2 is substantially the same as the vehicle-coolant heat insulating tube of embodiment 1 except having the protection layer.

Therefore, the vehicle-coolant heat insulating tube of embodiment 2 is the vehicle-coolant heat insulating tube of the first aspect and the vehicle-coolant heat insulating tube of the second aspect. In addition, a manufacturing method of embodiment 2 is the manufacturing method of the third aspect and the manufacturing method of the fourth aspect. Therefore, the vehicle-coolant heat insulating tube of embodiment 2 is also considered to be the vehicle-coolant heat insulating tube of the fifth aspect and the vehicle-coolant heat insulating tube of the sixth aspect.

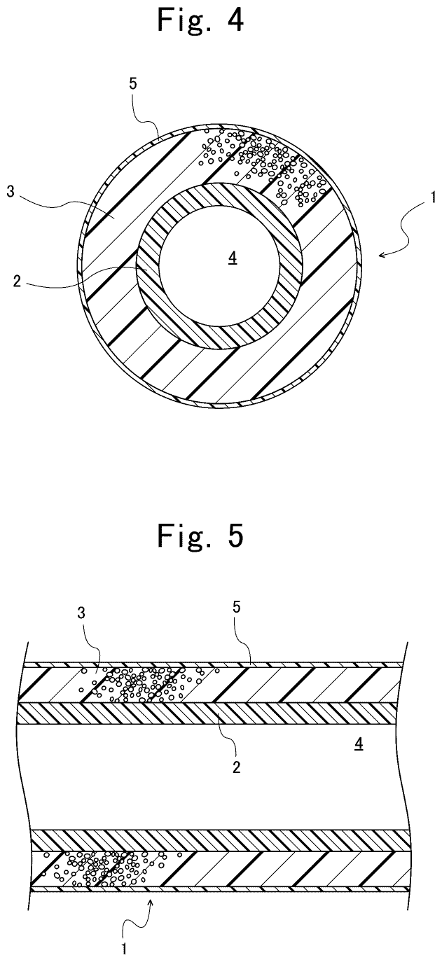

FIG. 4 schematically illustrates a radial-direction cross-section of the vehicle-coolant heat insulating tube of embodiment 2. FIG. 5 schematically illustrates an axial-direction cross-section of the vehicle-coolant heat insulating tube of embodiment 2.

Hereinafter, the vehicle-coolant heat insulating tube and the manufacturing method therefor of embodiment 2 will be described focusing on difference from the vehicle-coolant heat insulating tube of embodiment 1.

As shown in FIG. 4 and FIG. 5, the vehicle-coolant heat insulating tube 1 of embodiment 2 has a protection layer 5 covering the entire surface of the heat insulating layer 3 from the radially outer side. The protection layer 5 is made of PA foam, and the porosity thereof is approximately 10%. In addition, the thickness of the protection layer 5 is approximately 1 mm and is approximately 0.6 to 0.7 times the thickness of the flow path formation layer 2.

The melting point of PA is higher than the melting point of TPO. Therefore, in the vehicle-coolant heat insulating tube 1 of embodiment 2, the protection layer 5 whose material is PA foam has higher heat resistance than the heat insulating layer 3 whose material is TPO foam.

In the vehicle-coolant heat insulating tube 1 of embodiment 2, the outer side of the heat insulating layer 3 is further covered by the protection layer 5, whereby high heat resistance is imparted to the vehicle-coolant heat insulating tube 1 and thus durability of the vehicle-coolant heat insulating tube 1 is improved.

In the vehicle-coolant heat insulating tube of embodiment 2, as in the vehicle-coolant heat insulating tube 1 of embodiment 1, a sufficient heat insulation property based on the heat insulating layer 3 is imparted.

In the vehicle-coolant heat insulating tube 1 of embodiment 2, as in the vehicle-coolant heat insulating tube 1 of embodiment 1, the strength and the rigidity of the flow path formation layer 2 are sufficiently increased, whereby the shape thereof is stably maintained also in bending work and usage. In addition, in the vehicle-coolant heat insulating tube 1 of embodiment 2, as in the vehicle-coolant heat insulating tube 1 of embodiment 1, the connection strength to the target member is sufficiently increased.

The manufacturing method for the vehicle-coolant heat insulating tube 1 of embodiment 2 includes the same extrusion molding step as in the manufacturing method for the vehicle-coolant heat insulating tube 1 of embodiment 1.

More specifically, in the manufacturing method for the vehicle-coolant heat insulating tube of embodiment 2, in the extrusion molding step, the flow path formation material which is the material of the flow path formation layer 2, the heat insulating material which is the material of the heat insulating layer 3, and a protection material which is the material of the protection layer 5 were separately put into feeders of an extrusion molding machine (not shown), and then through a mold of the extrusion molding machine, a straight tubular body having the flow path formation layer 2, the heat insulating layer 3, and the protection layer 5 was extrusion-molded.

The tubular body obtained in the extrusion molding step was bent while being heated, whereby the vehicle-coolant heat insulating tube 1 of embodiment 2 bent substantially in an L shape was obtained.

With the manufacturing method for the vehicle-coolant heat insulating tube 1 of embodiment 2, the flow path formation layer 2, the heat insulating layer 3, and the protection layer 5 are integrally molded in the extrusion molding step, thus obtaining the vehicle-coolant heat insulating tube 1 of embodiment 2 having the heat insulating layer 3 and the protection layer 5 in a compact size without waste, unlike the existing vehicle-coolant heat insulating tube of the wound-adhered type described above.

In addition, with the manufacturing method for the vehicle-coolant heat insulating tube 1 of embodiment 2, the flow path formation layer 2, the heat insulating layer 3, and the protection layer 5 are molded at the same time in the extrusion molding step, whereby the flow path formation layer 2 and the heat insulating layer 3 are fused to be strongly joined to each other and the heat insulating layer 3 and the protection layer 5 are fused to be strongly joined to each other.

Thus, with the manufacturing method for the vehicle-coolant heat insulating tube 1 of embodiment 2, separation between the flow path formation layer 2 and the heat insulating layer 3 is suppressed with high reliability and separation between the heat insulating layer 3 and the protection layer 5 is suppressed with high reliability. As a result, the vehicle-coolant heat insulating tube 1 of embodiment 2 having high strength and high durability is obtained.

While the present disclosure has been described above, the present disclosure is not limited to the embodiments and the like described above. Elements described in the embodiments and the like may be selected and combined as appropriate to implement the present disclosure, and various modifications may be made without deviating from the scope of the present disclosure.

The specification of the present disclosure discloses not only technical features based on the reference relationship of the claims at the time of filing of the present application but also technical features obtained by combining matters described in the claims as appropriate.

1. A vehicle-coolant heat insulating tube having a flow path for a vehicle coolant, the vehicle-coolant heat insulating tube comprising:
a flow path formation layer defining and forming the flow path therein; and
a heat insulating layer covering the flow path formation layer from a radially outer side, wherein
a porosity of the flow path formation layer is smaller than 20%, and a porosity of the heat insulating layer is 20% or greater and smaller than 80%.

2. A vehicle-coolant heat insulating tube having a flow path for a vehicle coolant, the vehicle-coolant heat insulating tube comprising:
a flow path formation layer defining and forming the flow path therein; and
a heat insulating layer covering the flow path formation layer from a radially outer side, wherein
a Young's modulus of the flow path formation layer is 1000 MPa or greater and 4000 MPa or smaller, and a Young's modulus of the heat insulating layer is smaller than 1000 MPa.

3. The vehicle-coolant heat insulating tube according to claim 1, wherein
a Young's modulus of the flow path formation layer is 1000 MPa or greater and 4000 MPa or smaller.

4. The vehicle-coolant heat insulating tube according to claim 2, wherein
a porosity of the heat insulating layer is 20% or greater and smaller than 80%.

5. The vehicle-coolant heat insulating tube according to claim 1, further comprising a protection layer covering the heat insulating layer from a radially outer side, wherein
a porosity of the protection layer is smaller than 20%.

6. The vehicle-coolant heat insulating tube according to claim 2, further comprising a protection layer covering the heat insulating layer from a radially outer side, wherein
a porosity of the protection layer is smaller than 20%.

7. A manufacturing method for a vehicle-coolant heat insulating tube which has a flow path for a vehicle coolant and includes a flow path formation layer defining and forming the flow path therein and a heat insulating layer covering the flow path formation layer from a radially outer side, the manufacturing method comprising:
an extrusion molding step of performing extrusion molding using a flow path formation material which is a material of the flow path formation layer and a heat insulating material which is a material of the heat insulating layer, to form the flow path formation layer having a porosity of smaller than 20% and the heat insulating layer having a porosity of 20% or greater and smaller than 80%.

8. A manufacturing method for a vehicle-coolant heat insulating tube which has a flow path for a vehicle coolant and includes a flow path formation layer defining and forming the flow path therein and a heat insulating layer covering the flow path formation layer from a radially outer side, the manufacturing method comprising:
an extrusion molding step of performing extrusion molding using a flow path formation material which is a material of the flow path formation layer and a heat insulating material which is a material of the heat insulating layer, to form the flow path formation layer having a Young's modulus of 1000 MPa or greater and 4000 MPa or smaller, and the heat insulating layer having a Young's modulus of smaller than 1000 MPa.

9. A vehicle-coolant heat insulating tube extrusion-molded by the manufacturing method according to claim 7.

10. A vehicle-coolant heat insulating tube extrusion-molded by the manufacturing method according to claim 8.
